(19) United States
(12) Patent Application Publication
(10) Pub. No.: US 2006/0238610 A1
(43) Pub. Date: Oct. 26, 2006

(54) Portable locator methods and systems

(76) Inventor: Peter Wolfgang Teesdale, Tuscaloosa, AL (US)

Correspondence Address: Paul D. Greeley;Ohlandt , Greeley, Ruggiero & Perle, L.L.P., 10th Floor, One Landmark Square, Stamford, CT, 06901-2682, US

(21) Appl. No.: 11/367,947

(22) Filed: Mar. 3, 2006

Related U.S. Application Data
(60) Provisional application No. 60/658,729, filed on Mar. 4, 2005.

(51) Int. Cl. H04N 7/14

(52) U.S. Cl. 348/14.02; 340/539.13

(57) ABSTRACT

A method of tracking a person or object within a desired area is provided. The method includes associating a locator device to the person or object; setting a regarded map representative of the desired area in a portable monitoring device; calibrating the portable monitoring device to the locator device; and displaying a location of the person or object on the portable monitoring device with respect to the regarded map.

### CROSS REFERENCE TO RELATED APPLICATIONS

This application claims the benefit of U.S. Provisional Application Ser. No. 60/658,729, filed Mar. 4, 2005, the contents of which are incorporated by reference herein.

### BACKGROUND OF THE INVENTION

1. Field of the Invention

This application relates to portable locator methods and systems for monitoring and/or verifying the location of objects and/or people. More particularly, this application relates to methods and portable devices for monitoring and/or verifying the location of objects and/or people.

2. Description of Related Art

The field of wireless communications to locate objects, generally for child, car and/or animal location, has been well documented. The general location mechanisms are defined by a combination of transceivers and potential third-party systems like GPS systems or ground-based systems to determine the current position of the desired person. In such systems, transceivers transmit and receive signals so that the desired positional data can be determined.

Other prior applications are iterations of the same theme whereby a locator is attached to the object or child that renders positional data by GPS systems, cellular communication systems, radio beacon detectors and so on.

However, there is a continuing need for further improvements in the field of portable locator systems and devices.

### SUMMARY OF THE INVENTION

A locator system to enable monitoring and verification of objects within a predefined geographical area is provided. The system includes a portable console unit with a display device enabled by software for visual or otherwise depiction of geographical location of one or more locator devices. The console unit wirelessly polls the locator devices to continually establish a geographical location of the locator devices. The locator devices receive and/or transmit relational geographical location data to the console unit.

A method of tracking a person or object within a desired area is provided. The method includes associating a locator device to the person or object; setting a regarded map representative of the desired area in a portable monitoring device; calibrating the portable monitoring device to the locator device; and displaying a location of the person or object on the portable monitoring device with respect to the regarded map.

A method of tracking people within a desired area is also provided. The method includes loading a regarded map on a first portable console unit; associating a first locator device to the first portable console unit; associating the first locator device to a first person; associating the first portable console unit to a second person; and displaying a location of the first person on the first portable console unit with respect to the regarded map.

A locator system is also provided that includes a portable console unit, a locator device, and a regarded map. The portable console unit has a display device. The locator device is configured to be carried by a person to be tracked. The regarded map is displayed on the display unit and the regarded map includes a location of the locator device with respect to the regarded map.

The above-described and other features and advantages of the present invention will be appreciated and understood by those skilled in the art from the following detailed description, drawings, and appended claims.

### BRIEF DESCRIPTION OF THE DRAWINGS

FIG. 1 illustrates an exemplary embodiment of a portable locator system according to the present disclosure;

FIG. 2 is a front view of an exemplary embodiment a console unit for use with the system of FIG. 1;

FIG. 3 is a first side view of the console unit of FIG. 2;

FIG. 4 is a second side view of the console unit of FIG. 2; and

FIG. 5 illustrates an exemplary embodiment of a locator device for use with the system of FIG. 1.

### DETAILED DESCRIPTION OF A PREFERRED EMBODIMENT

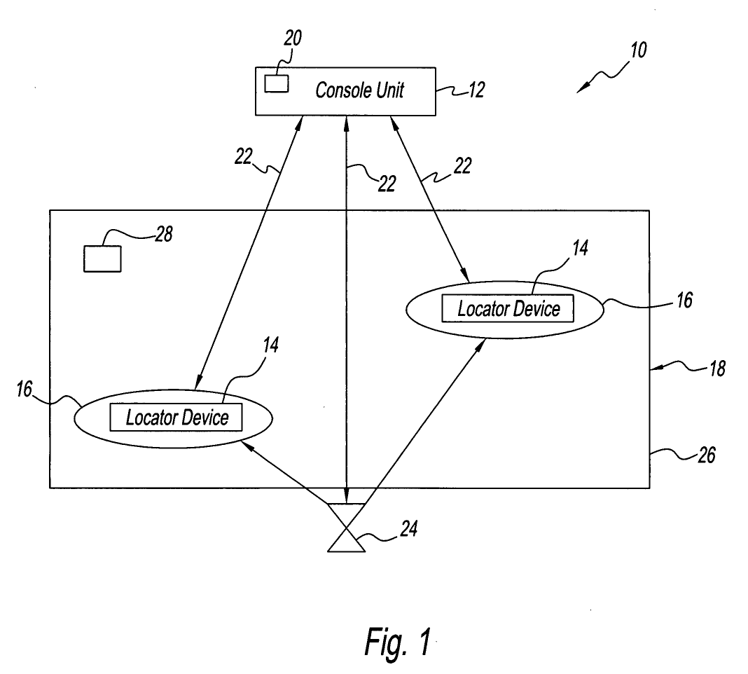

Referring now to FIG. 1, an exemplary embodiment of a locator system 10 according to the present disclosure is shown. System 10 includes a portable console unit 12 and one or more locator devices 14. Locator devices 14 can be attached to or otherwise associated with an object 16 to be tracked. System 10 is configured to display the location of object 16 on console unit 12 within a regarded map or area 18.

Console unit 12 is a portable digital unit having a display device 20. As used herein, the term “portable” shall mean that the unit that can be carried by and/or on a person. Console unit 12 can be a standalone device used solely for locator system 10. Alternately, console unit 12 can be integrated into any portable digital unit having display device 18 such as, but not limited to a laptop computer, a personal digital assistant (PDA), a cell phone, a beeper, a wireless communication device, a portable Global Positioning System (GPS) Receiver and any combinations thereof. In an exemplary embodiment, console unit 12 can be a PDA such as those available under the tradenames Palm Pilot, iPod, Treo, and others.

Locator device 14 can be an active device that actively sends locating signals, a passive device that can be detected by locating signals, or any combination thereof. In an exemplary embodiment, object 16 can be a person (e.g., a child, soldier, etc.), an animal (e.g., a pet), a car, cargo, goods, machinery, or any other object whose location is to be tracked. For example, locator device 14 can be embedded in a carrier device (not shown) such as, but not limited to, a running shoe, a watch, a cell phone, a PDA, and the like, where the carrier device can be associated (e.g., worn, carried, or otherwise attached) to the object 16.

Regarded map 18 is a relational coordinate system that allows a user to monitor the location of object 16 within a predefined area. In the example where locator device 14 is associated with a child, regarded map 18 can be a sporting stadium, a neighborhood, a park (e.g., Disney World), arenas, malls, universities, and other locations. In this manner, system 10 allows a user having console unit 12 to view the location of the tagged object or person 16 on regarded map 18.

Regarded map 18 can be stored in memory resident on console unit 12. For example, regarded map 18 can be stored on an e-prom resident on control unit 12. Regarded map 18 can be stored on a readable storage device such as a DVD or jump drive, which can be read by console unit 12.

It is contemplated by the present disclosure for the user to have the ability to change, adjust, or set regarded map 18. For example, it is contemplated for the user to download via a wired or wireless connection the regarded map 18 onto console unit 12. In another example, console unit 12 can be carried about the area to be set as regarded map 18 and enter in one or more points that define the regarded map.

It is also contemplated for the user to set limits 26 within regarded map 18, where the console unit 12 will alarm the user in the event that locator device 14 moves outside of limits 26. In the illustrated embodiment, limits 26 are shown for purposes of clarity as being the extent of regarded map 18. Of course, it is contemplated by the present disclosure for limits 26 to be wholly within regarded map 18. In this manner, system 10 can notify a parent when a child moves outside of the area defined by limits 26 or enters an area defined by limits 26.

Further, it is contemplated for the user to set a particular point of interest 28 such as, but not limited to a car location, a seat location, an emergency meeting point, within regarded map 18.

In one embodiment, console unit 12 is configured to determine the geographical coordinates of locator devices 14 from reception of signals 22 from a transmitter 24. Transmitter 24 can be a GPS system, a ground-based technology, radio frequency system (e.g., a wireless network such as WIFI), and others. In another embodiment, console unit 12 wirelessly sends and receives signals 22 from locator devices 14.

In either embodiment, console unit 12 is a self-contained portable console unit which, through generalized wireless communications, provides in graphical and/or textual from the location of locator devices 14 within regarded map 18 on console unit 12. Thus, console unit 12 translates signals 22 into a set of coordinates and relates those coordinates to regarded map 18. Console unit 12 displays the location of locator device 14 on display device 20 within regarded map 18. For example, display device 20 can graphically display and/or textually display the relational coordinates of locator devices 14 on console unit 12. Thus, console unit 12 can be configured to perform all necessary calculations for determining the coordinates of locator device 14. This embodiment may be particularly useful where console unit 12 is a stand-alone device.

In a second embodiment, console unit 12 can receive signals 22 having the coordinates of locator device 14 already calculated. In this embodiment, console unit 12 merely receives wireless signals 22 and displays the location of locator devices 14 on regarded map 18. This embodiment may be particularly useful where the functionality of console unit 12 is embedded within a pre-existing portable electronic device.

In use, console unit 12 is synchronized or calibrated to detect one or more locator devices 14. Hence, a novel feature of the console locator system is the fact that it be carried to the mapped geographical area and the locator device immediately monitored and tracked therein once synced with the console.

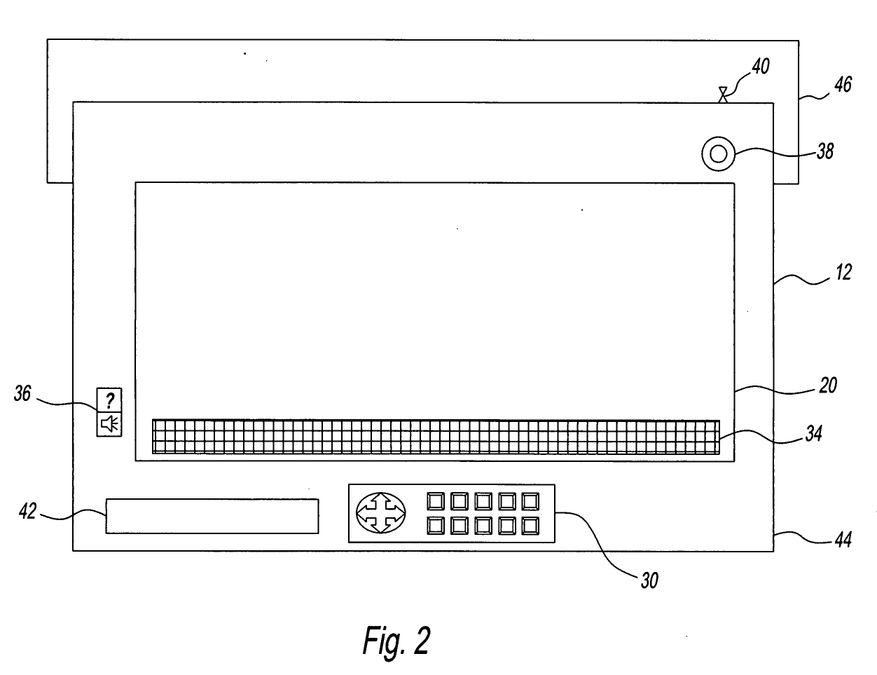

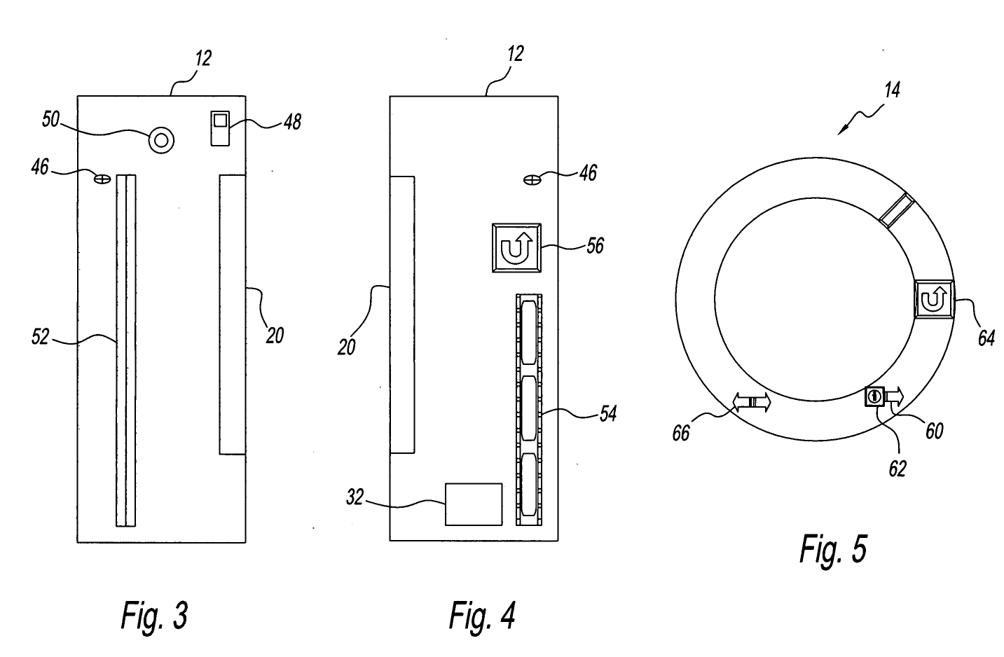

Referring now to FIGS. 2 through 4, an exemplary embodiment of a stand-alone console unit 12 is shown.

The primary interpretation of geographical location data of locator device(s) is through the console unit's display device 20, such as a LCD screen. Display device 20 displays regarded map 18 and the location of locator device 14 in the regarded map. Display device 20 can be a textual geographical display, touchscreen, a color screen, or other displays for communicating the relative geographical position with respect to regarded map 18.

Console unit 12 can include one or more input devices 30, such as a directional dial and keypad. Input devices 30 allow for interactive access and zooming capabilities; for syncing of locator devices 14, saving data, retrieving data, ad hoc interrogation of locator device whereabouts specific to the geographical area under consideration, defined selection options for instance predetermining safe ranges within the regarded mappings and alert signal settings on close proximity and contravention, data storage, scrolling of synced locator devices, and other optional related functions. The scope of the function of input devices will be determined by the model type of the console unit and complexity of operations sought.

Console unit 12 can include a processor and/or memory 32. The present disclosure proposes a memory (EPROM, RAM, DDR, memory card, as required) capability to store and retrieve geographical and locator device(s) data, historical and/or real time, and other related data together with an operating system (control unit, arithmetic logic unit, ROM) and related microchip hardware requirements for operation and control of all functions pertinent to the unit and system. Circuitry for a clock timer, for example for standard internal operations of the unit as well as any time stamping requirements for any transmission records, alarm settings, are assumed and will be obvious to those skilled in the art.

In some embodiments, console unit 12 can also include, in addition to and/or as part of display device 20, a display window 34 wherein the identity of each locator device 14 can be displayed, indicating relational geographic coordinate location data.

Console unit 12 can include a recall button 36, which may be manually activated by a user of the console unit or may be activated based upon a programmed time elapse. Recall button 36 can activate an alarm (not shown) on locator device 14. Thus, console unit 12 allows the user to cause locator device to provide a visual notification, an audible notification, a vibratory notification, and any combinations thereof. The notification on locator device can be used, in the example where a person is associated with locator device 14, to indicate to the person that the user of the console unit desires a particular activity, such as returning home or making contact.

Console unit 12 can include an audible indicator 38 and/or a visual indicator (not shown) for notifying the user of the console unit of one or more alarm conditions. In one embodiment, audible indicator 38 can be manually activated by a user of locator device 14. Thus, console unit 12 allows the user to receive a visual and/or audible notification from the locator device 14. In addition, audible indicator 38 can be sounded in tandem with a clock timer to alert the parent of a given elapsed time, such that certain actions can then be taken, for instance recalling the locator device(s).

Console unit 12 can include an antenna 40 for wireless communication purposes. It is contemplated for antenna 40 to be embedded in console unit 12 itself and, hence, not visible.

Console unit 12 includes a battery 42 for providing power to the unit and a power switch 48 for powering on or off the console unit. Console unit 12 can include a power cord inlet 50 (e.g., AC adapter connector). In one embodiment, no location of any locator devices 14 will be performed if console unit 12 is off to preserve power of battery 42.

As console unit 12 is a stand-alone unit, it includes a sturdy casing 44 for robustness and long-term usage, especially given the nature of the portability of the device. Design considerations should include limited and reasonable dropping of the unit not rendering the unit inoperable, with further mechanisms to allow for a degree of waterproofing. Some design options for incorporating the sturdy casing and LCD screen may entail a retractable LCD screen itself or an overall latch cover to protect the screen from any untoward damage. Further, console unit 12 may include a secured cord or strap and/or handle 46.

In the illustrated embodiment, console unit 12 includes an electronic medium drive 52, such as a DVD drive for receipt of regarded map 18. Of course, it is contemplated by the present disclosure for electronic medium drive 52 to include CD/DVD/CD-RW drives, memory sticks or cards, optical media reading devices, and others.

Console unit 12 can also include one or more connector ports 54 to allow the console unit to connect to and allow for any of the following: software upload/download; connection to the World Wide Web or otherwise; other hardware and software for example drivers requirements for a docking unit interface, peripheral attachment interfaces (for instance a mouse), and infrared devices; ability to upload and/or download data to a determined web site for upgrade and/or historical capture respectively; wherein the generalized hardware design comprises the above in form and function and is not limited to such, fit and number may be altered for hardware compliance and will be known to those skilled in the art.

Console unit 12 is also shown in the illustrated embodiment having a sync-station mechanism 56. Sync-station mechanism 56 can be used to synchronize or calibrate control unit 12 to detect a particular locator device 14. Of course, it is contemplated by the present disclosure for sync-station mechanism 56 to be embedded in input devices 30. Thus, the sync-station mechanism 56 can be effected by either direct interface connection with locator device 14 and/or infrared interfacing of the selected locator device or otherwise.

Turning now to FIG. 5, an exemplary embodiment of locator device 14 is shown. Locator device 14, in its primary embodiment, is attached or appended to a child or other person or object to be monitoring and location verified, per regarded mapping. The locator device 16 can take any of the following forms, and is not restricted to such: bracelet, wristband, computer chip (such chip fashioned to lace into a child's shoe laces or as an article of clothing, a button for instance), cable tie, ankle strap, necklace, cell phone, pager, watch, or other object or attachment. Each form indicates inherent simplicity or conversely complexity and many such locator devices exist. This present disclosure proposes a unique console unit that can be synced with any of such, as model type would allow, for monitoring and location verification. Added to the requirements of any such locator device, is the fact that it must be a well-secured mechanism and that any non-specified interference in its removal will result in an alarm signal on the console per alarm signal speaker and/or voice processor 38. Any of an assortment of secure locking mechanisms is advised as would relate to the specific locator device, and as would thereto apply.

As discussed above, audible indicator 38 of console unit 12 can be manually activated by a user of locator device 14. For example, locator device 14 can include a panic button 60. On activation of panic button 60, immediate transmission is fed back to console unit 12. In some embodiments, panic button 60 can be linked to a local law enforcement agency or/and more regionally to the 911 system.

As also discussed above, depressing of recall button 36 of console unit 12 can activate an alarm 62 on locator device 14. Alarm 62 can be a blinking or steady light, noise, vibratory response or otherwise. This relay notifies the object of a present action to be taken, for instance to alert a child to return to a predetermined location, or to move back to a safe zone or boundary parameter.

Locator device 14 can include a sync-station interface 64 for communication with sync-station mechanism 56 of console unit 12. As noted above, compatibility with the sync-station mechanism 56 is essential for the console unit 12 to recognize and incorporate the locator device 14.

Further, locator device 14 can include an active or passive component 66 for communication with transmitter 24 of system 10.

Unlike prior systems that determine the location of the holder of the device with respect to a map, system 10 determines the location of locator device 14 with respect to regarded map 18. Thus, system 10 allows the user to determine the location of others with respect to the location of the console unit 12.

In the example where console unit 12 is a stand-alone unit, system 10 finds use in many tourist locations, such as a national park or amusement park. Here, system 10 can be offered as a rental service to users of the tourist location. In one example, a service of using system 10 can be offered on a rental basis. For example, a parent can rent console unit 12 and can rent a locator device 14 for each of their children. The console unit 12 is pre-programmed with regarded map 18, which corresponds to the tourist location. In this manner, the parent can monitor and locate the position of any child within the tourist location.

In some embodiments, system 10 is a circular system where each console unit 12 also includes locator device 14. Here, a group or number of users can each have console unit 12 and, thus, can determine the location of the rest of the group within regarded map 18 relative to one another and relative to themselves.

In embodiments were system 10 is implemented using existing portable electronic devices, the functionality of the system can be stored on a readable electronic medium. The readable electronic medium can be downloaded to a portable electronic device and then be used with any number of locator devices. For example, a cellphone provider may offer system 10 as a service to customers on their network. Here, the cell phone provider can perform all necessary calculations for determining the coordinates of locator device 14 and merely provide signals 22 to console unit 12.

The use of system 10 can be as follows: first, a regarded map can be loaded on a console unit; next, one or more locator devices are associated to the console unit and to an object to be located; and finally the location of the one or more locator devices is displayed on the console with respect to their location on the regarded map.

A method of tracking a person within a desired area is also provided. The method includes associating a locator device to the person; setting a regarded map representative of the desired area in a monitoring device; and calibrating the monitoring device to the locator device. The monitoring device can be a portable electronic device. The electronic device can be a device selected from the group consisting of a portable computer, a cellphone, a personal digital assistant, a laptop, and any combinations thereof. The step of setting the regarded map can include downloading the regarded map from a database or any other preset medium, for instance a DVD. However, the step of setting the regarded map can include teaching the monitoring device the desired area by moving the monitoring device. Here, the step of teaching the monitoring device the desired area can include placing the monitoring device in a learn mode and moving the monitoring device to a plurality of locations defining a boundary of the desired area.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the present disclosure.

What is claimed is:

1. A method of tracking a person or object within a desired area, comprising:
associating a locator device to the person or object;
setting a regarded map representative of the desired area in a portable monitoring device;
calibrating said portable monitoring device to said locator device; and
displaying a location of the person or object on said portable monitoring device with respect to said regarded map.

2. The method of claim 1, wherein said portable monitoring device is a device selected from the group consisting a beeper, a laptop computer, a personal digital assistant, a cell phone, a portable Global Positioning System Receiver and any combinations thereof.

3. The method of claim 1, wherein setting said regarded map comprises downloading said regarded map from a database or other preset medium.

4. The method of claim 1, wherein setting said regarded map comprises teaching said portable monitoring device the desired area.

5. The method of claim 4, wherein teaching said portable monitoring device the desired area comprises placing said portable monitoring device in a learn mode and moving said portable monitoring device to a plurality of locations defining a boundary of the desired area.

6. A method of tracking people within a desired area, comprising:
loading a regarded map on a first portable console unit;
associating a first locator device to said first portable console unit;
associating said first locator device to a first person;
associating said first portable console unit to a second person; and
displaying a location of said first person on said first portable console unit with respect to said regarded map.

7. The method of claim 6, further comprising:
associating another locator device to said first portable console unit;
associating said another locator device to a third person; and
displaying a location of said another person on said first portable console unit with respect to said regarded map

8. The method of claim 6, wherein said first portable console unit further comprises a second locator device and said first locator device further comprises a second portable console unit.

9. The method of claim 8, further comprising:
loading said regarded map on said second portable console unit;
associating said second locator device to said second portable console unit; and
displaying a location of said second person on said second portable console unit with respect to said regarded map.

10. A locator system comprising:
a portable console unit having a display device;
a locator device to be carried by a person to be tracked; and
a regarded map or area displayed on said display unit, said regarded map including a location of said locator device with respect to said regarded map.

11. The locator system of claim 10, wherein said portable console unit is selected from the group consisting of a beeper, a laptop computer, a personal digital assistant, a cell phone, a portable Global Positioning System Receiver and any combinations thereof.

12. The locator system of claim 10, wherein said locator device is an active locator device, a passive locator device, or any combination thereof.

13. The locator system of claim 10, wherein said locator device is embedded in a carrier device carried by the person.

14. The locator system of claim 10, wherein said regarded map is stored in memory resident on said portable console unit.

15. The locator system of claim 10, wherein said regarded map comprises a user set limit, said portable console unit activating an alarm when said locator device moves outside of said user set limit.

16. The locator system of claim 10, wherein said regarded map comprises a user set point of interest.

17. The locator system of claim 10, wherein said portable console unit receives signals having said location.

18. The locator system of claim 10, wherein said portable console unit further comprises a display window, said display window identifying the person with which said locator device associated.

19. The locator system of claim 10, wherein said portable console unit further comprises a recall button, said recall button being configured to selectively activate an alarm on said locator device.

20. The locator system of claim 10, wherein said locator device further comprises a panic button, said panic button being configured to selectively activate an alarm on said portable console unit.
